(19) United States
(12) Patent Application Publication
(10) Pub. No.: US 2016/0291237 A1
(43) Pub. Date: Oct. 6, 2016

(54) BACKLIGHT MODULE, DISPLAY DEVICE AND METHOD FOR MANUFACTURING BACKLIGHT MODULE

(71) Applicants: BOE TECHNOLOGY GROUP CO., LTD., Beijing (CN); HEFEI BOE OPTOELECTRONICS TECHNOLOGY CO., LTD., Hefei (CN)

(72) Inventors: Yuanqin HE, Beijing (CN); Chang LV, Beijing (CN); Shounian CHEN, Beijing (CN)

(73) Assignees: BOE TECHNOLOGY GROUP CO., LTD., Beijing (CN); HEFEI BOE OPTOELECTRONICS TECHNOLOGY CO., LTD., Hefei (CN)

(21) Appl. No.: 14/739,020

(22) Filed: Jun. 15, 2015

(30) Foreign Application Priority Data
Mar. 30, 2015 (CN) 201510144073.2

(51) Int. Cl. F21V 8/00

(52) U.S. Cl. CPC G02B 6/0041; G02B 6/0065; G02B 6/0066; G02B 6/0031; G02B 6/0053; G02B 6/0051

(57) ABSTRACT

The present disclosure provides a backlight module, a display device and a method for manufacturing a backlight module. The backlight module includes a blue light emitting device and a light guide plate, wherein the light guide plate includes a substrate and a plurality of quantum dots which are of different diameters and doped in the substrate.

### CROSS-REFERENCE TO RELATED APPLICATION

This application claims priority to Chinese Patent Application No. 201510144073.2 filed on Mar. 30, 2015, the disclosure of which is incorporated in its entirety by reference herein.

### TECHNICAL FIELD

The present disclosure relates to the liquid crystal display field, in particular to a backlight module, a display device and a method for manufacturing a backlight module.

### BACKGROUND

A liquid crystal display device is a flat panel display device, its operating principle refers to that an image is formed due to various different changes in brightness and chrominance generated from a light modulating action of a liquid crystal material under an electric field. Since the liquid crystal material itself emits no light, a specialized backlight is required for all liquid crystal display devices. Light in a blue color is emitted from a blue light emitting device, and light in other colors (eg., red or green) is acquired when the light in the blue color irradiate to quantum dots in the backlight. The display performance of the liquid crystal display device may be evaluated by indicators such as color gamut and wave crest. Along with the development of the display technology, it has become an increasing demand for the display effect of the liquid crystal display device.

### SUMMARY

In view of the above, an object of the present disclosure is to provide a backlight module, a display device and a method for manufacturing a backlight module, so as to improve display effect of a display device.

In a first aspect, an embodiment of the present disclosure provides a backlight module, including a blue light emitting device and a light guide plate, wherein the light guide plate includes a substrate and a plurality of quantum dots which are of different diameters and doped in the substrate.

Alternatively, the backlight module further includes an upper diffusion sheet and a lower diffusion sheet which are arranged above the light guide plate, a prism sheet arranged between the upper diffusion sheet and the lower diffusion sheet, and a reflection sheet arranged below the light guide plate.

Alternatively, the quantum dots include red quantum dots and green quantum dots.

Alternatively, the red quantum dots and the green quantum dots are distributed uniformly in the substrate.

Alternatively, the quantum dots are of a diameter of 1 nm to 8 nm.

Alternatively, a portion of the quantum dots are of a diameter of 3 nm, and the rest portion of the quantum dots are of a diameter of 7 nm.

Alternatively, the substrate is polymethyl methacrylate (PMMA) or polycarbonate (PC).

In a second aspect, an embodiment of the present disclosure provides a display device, including the above backlight module.

In a third aspect, an embodiment of the present disclosure provides a method for manufacturing a backlight module, including: adding a plurality of quantum dots with different diameters into a to-be-molded material for a substrate of a light guide plate, stirring uniformly, and forming the light guide plate by using the to-be-molded material doped with the quantum dots.

Alternatively, the to-be-molded material is polymethyl methacrylate (PMMA) or polycarbonate (PC).

Alternatively, the method further includes injecting and molding the PMMA or PC, which is doped with quantum dots, by an injection molding machine to form the light guide plate.

At least parts of beneficial effects of the present disclosure are as follows: according to embodiments of the present disclosure, quantum dots are doped into the material for the substrate of the light guide plate, so as to prevent the backlight module from being of an increased thickness due to coating quantum dot layer, avoid peripheries of the backlight module from being of a blue edge caused by quantum dots oxidation, heighten spectrum peaks of light in other colors excited by irradiating the blue light to the quantum dots, and improve the color gamut, thereby to optimize the display effect.

### BRIEF DESCRIPTION OF THE DRAWINGS

FIG. 1 is a schematic diagram showing a backlight module according to an embodiment of the present disclosure;

FIG. 2 is a schematic diagram showing a backlight module in the related art; and

FIG. 3 is a comparison diagram showing light power spectral densities between the backlight modules according to the embodiment of the present disclosure and in the related art.

### DETAILED DESCRIPTION

In order to make the objects, technical solutions and advantages more apparent, detailed descriptions will be given below in conjunction with the accompanying drawings and embodiments of the present disclosure.

FIG. 2 is a schematic diagram showing a backlight module in the related art. For the backlight module, a quantum optical film 201 is arranged above a light guide plate 202. As the quantum optical film 201 itself is thick, an entire thickness of the backlight module is increased accordingly. Besides, the quantum optical film 201 is prone to have nonuniform problems. In addition, it is difficult to control a density of the quantum dots during manufacturing the quantum optical film, resulting in a poor uniformity, thus red spectrum and green spectrum, generated by exciting quantum dots in the quantum optical film with the light in the blue color, are of low wave crest and narrow color gamut, thereby lead to poor visual effect.

For the backlight module according to the present disclosure, quantum dots are doped in the substrate, so that it is not required to arrange a quantum dot coating layer, by which the quantum dots are not in contact with air, thereby to avoid peripheries of the backlight module from being of a blue edge caused by quantum dots oxidation, and improve the display effect.

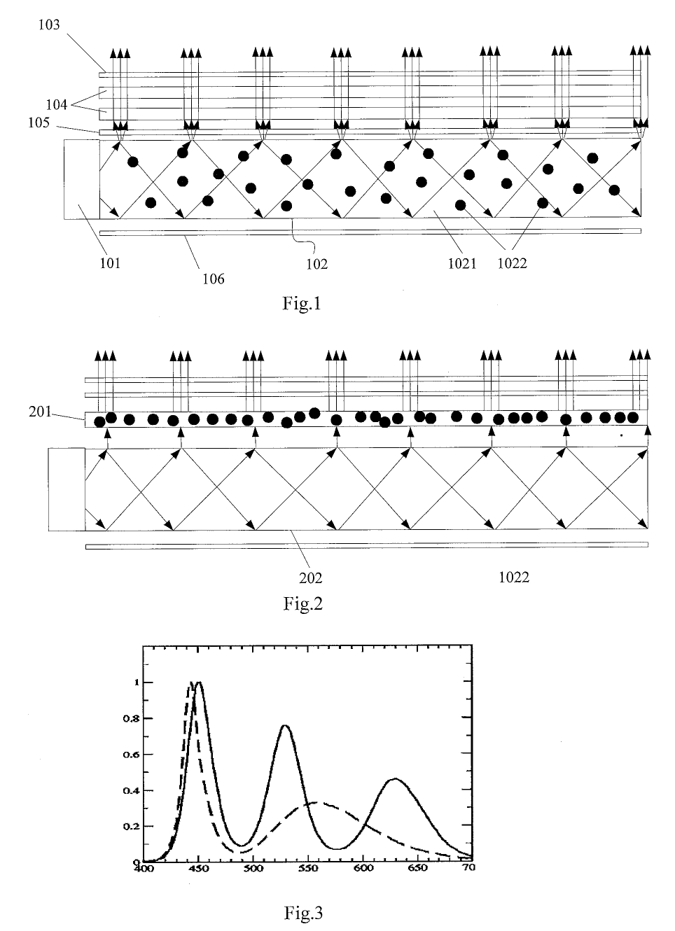

In one aspect, the present disclosure provides in embodiments a backlight module. As shown in FIG. 1, the backlight module includes a blue light emitting diode 101 and a light guide plate 102, wherein the light guide plate includes a substrate 1021 and a plurality of quantum dots 1022 which are of different diameters and doped in the substrate 1021.

The blue light emitting diode 101 servers as a blue light emitting device which emits light in a blue color. Light in different colors is generated by projecting the light in the blue color to the quantum dots 1022 with different diameters, such as light in red and green colors. In some embodiments of the present disclosure, the backlight module further includes an upper diffusion sheet 103 and a lower diffusion sheet 105 arranged above the light guide plate 102, a prism sheet 104 arranged between the upper diffusion sheet 103 and the lower diffusion sheet 105, and a reflection sheet 106 arranged below the light guide plate. The light in the blue color emitted from the blue light emitting diode 101 is converted to light in other colors after passing through the light guide plate 102 and then projected to quantum dots 1022, so that, light emitted from the light guide plate 102 includes light in the blue and other colors. Such light forms uniform emergent light in a consistent direction after adjusted through the lower diffusion sheet 105, the prism sheet 104 and the upper diffusion sheet 103.

In some embodiments of the present disclosure, the quantum dots include red quantum dots and green quantum dots. The light in the blue color emitted from the blue light emitting diode 101 is converted to light in red and green colors after projected to the red quantum dots and the green quantum dots, respectively. Light of backlight source is formed by mixing such light in red and green colors as well as light reflected by the reflection sheet 106.

In some embodiments of the present disclosure, the red quantum dots and the green quantum dots are distributed uniformly in the substrate 1021. As the quantum dots 1022 can doped in the substrate before the substrate 1021 are molded, the quantum dots 1022 can distributed uniformly in the substrate 1021, thereby to broaden the color gamut of the light.

FIG. 3 is a comparison diagram showing light power spectral densities of between the backlight module according to the embodiment of the present disclosure and in the related art, which illustrates power spectral densities of light at different wavelengths generated by the backlight module according to an embodiment of the present disclosure and in the related art, respectively. In the figure, the solid line represents the power spectral density of light at different wavelengths generated by the backlight module according to an embodiment of the present disclosure, the dotted line represents the power spectral density of light at different wavelengths generated by the backlight module in the related art; the horizontal axis represents the wavelengths, and the vertical axis represents the power spectral densities. It can be seen that, the backlight module according to an embodiment of the present disclosure is of wave crest higher than that in the related art, so as to broaden the color gamut of the display material, thereby to improve the display effect.

In some embodiments of the present disclosure, the quantum dots are of a diameter of 1 nm to 8 nm It is usually required to emit light in blue, red and green colors from the backlight module. Light in the blue color projected to the quantum dots can be converted to light in different colors in accordance with different diameter of the quantum dots. Therefore, the quantum dots may be any types of quantum dots, to which the light in the blue color is projected thereby to generate the light in a red or green color. Further, as the light in the green color may be obtained by mixing the light in blue and yellow colors, in some embodiments, the quantum dots may be any types of quantum dots, to which the light in the blue color is projected thereby to generate the light in the yellow color.

In some embodiments of the present disclosure, a portion of the quantum dots is of a diameter of 3 nm, the rest quantum dots are of a diameter of 7 nm. A green spectrum is generated by projecting the light in the blue color to the quantum dots with the diameter of 3 nm, and a red spectrum is generated by projecting the light in the blue color to the quantum dots with the diameter of 7 nm

In another aspect, the present disclosure further provides in embodiments a display device, including the backlight module according to any embodiment of the present disclosure.

In yet another aspect, the present disclosure further provides in embodiments a method for manufacturing a backlight module. The method includes: adding a plurality of quantum dots with different diameters into a to-be-molded material for a substrate of a light guide plate, stirring uniformly, and forming the light guide plate by the to-be-molded material doped with quantum dots. Because the light guide plate may be made by adding a plurality of quantum dots with different diameters before the substrate of the light guide is molded, then it is easy to control the distribution and uniformity of these quantum dots. As a result, the wave crest of the red and green spectrum is improved, thereby to broaden the color gamut of the display module and to improve display effect.

In some embodiments of the present disclosure, the to-be-molded material is polymethyl methacrylate (PMMA) or polycarbonate (PC).

In some embodiments of the present disclosure, the method further includes injecting and molding PMMA or PC, which is doped with quantum dots, by an injection molding machine, to form the light guide plate.

It can be seen from the above that, for the backlight module, the display device and the method for manufacturing the backlight module according to the present disclosure, the material for the substrate of the light guide plate is doped with the quantum dots with different diameters, so as to prevent the backlight module from being of an increased thickness due to coating quantum dot layer, avoid peripheries of the backlight module from being of a blue edge caused by quantum dots oxidation, heighten spectrum peaks of light in other colors excited by irradiating the blue light to the quantum dots, and improve the color gamut, thereby to optimize the display effect.

It should be appreciated that embodiments described herein are only for illustrating and interpreting the present disclosure, but not intended to limit the present disclosure. And under circumstances without a conflict, the embodiments and features described therein can be combined to each other.

What is claimed is:

1. A backlight module, comprising a blue light emitting device and a light guide plate, wherein the light guide plate comprises a substrate and a plurality of quantum dots which are of different diameters and doped in the substrate.

2. The backlight module according to claim 1, further comprising
an upper diffusion sheet and a lower diffusion sheet which are arranged above the light guide plate, a prism sheet arranged between the upper diffusion sheet and the lower diffusion sheet, and a reflection sheet arranged below the light guide plate.

3. The backlight module according to claim 1, wherein the quantum dots comprise red quantum dots and green quantum dots.

4. The backlight module according to claim 2, wherein the quantum dots comprise red quantum dots and green quantum dots.

5. The backlight module according to claim 3, wherein the red quantum dots and the green quantum dots are distributed unifonnly in the substrate.

6. The backlight module according to claim 4, wherein the red quantum dots and the green quantum dots are distributed uniformly in the substrate.

7. The backlight module according to claim 3, wherein the quantum dots are of a diameter of 1 nm to 8 nm.

8. The backlight module according to claim 4, wherein the quantum dots are of a diameter of 1 nm to 8 nm.

9. The backlight module according to claim 7, wherein a portion of the quantum dots are of a diameter of 3 nm, and the rest portion of the quantum dots are of a diameter of 7 nm.

10. The backlight module according to claim 8, wherein a portion of the quantum dots are of a diameter of 3 nm, and the rest portion of the quantum dots are of a diameter of 7 nm.

11. The backlight module according to claim 1, wherein the substrate is made of polymethyl methacrylate (PMMA) or polycarbonate (PC).

12. A display device, comprising the backlight module according to claim 1.

13. A method for manufacturing a backlight module, comprising:
adding a plurality of quantum dots with different diameters into a to-be-molded material for a substrate of a light guide plate, stirring uniformly, and forming the light guide plate by the to-be-molded material doped with the quantum dots.

14. The method according to claim 13, wherein the to-be-molded material is polymethyl methacrylate (PMMA) or polycarbonate (PC).

15. The method according to claim 13, further comprising
injecting and molding PMMA or PC, which is doped with quantum dots, by an injection molding machine, to form the light guide plate.
